(19) United States
(12) Patent Application Publication
(10) Pub. No.: US 2006/0113288 A1
(43) Pub. Date: Jun. 1, 2006

(54) Method and apparatus for simultaneous block melting of material by laser

(76) Inventors: Yasunori Kawamoto, Toyota-city (JP); Fumio Kawanishi, Nukata-gun (JP); Hideaki Shirai, Okazaki-city (JP)

Correspondence Address: HARNESS, DICKEY & PIERCE, P.L.C., P.O. BOX 828, BLOOMFIELD HILLS, MI, 48303, US

(21) Appl. No.: 11/332,871

(22) Filed: Jan. 16, 2006

Related U.S. Application Data
(62) Division of application No. 10/715,168, filed on Nov. 17, 2003.
Application No. 10/715,168 is a division of application No. 10/300,402, filed on Nov. 20, 2002, now abandoned.

(30) Foreign Application Priority Data
Nov. 26, 2001 (JP) 2001-359768

(51) Int. Cl. B23K 26/067

(52) U.S. Cl. 219/121.73; 219/121.65

(57) ABSTRACT

A low cost method and apparatus for simultaneous block melting of a material by laser enabling completion of work in a short time. A laser beam from a YAG laser source etc. strikes a diffraction type optical element like a diffraction lens and is split into a large number of beams by diffraction and transmission. The beams are focused by a condensing lens etc. on a plastic surface as a large number of points or a line. The plastic is simultaneously heated to melt at these focused points for welding with another object or for removal. Therefore, no deformation occurs in the worked material like in the prior art where a surface was scanned by a focused point. The worked material may be a metal etc. in addition to a plastic.

### CROSS-REFERENCE TO RELATED APPLICATIONS

This application is a divisional of U.S. patent application Ser. No. 10/715,168 filed on Nov. 17, 2003 which is a divisional of U.S. patent application Ser. No. 10/300,402 filed Nov. 20, 2002. This application claims the benefit of JP 2001-359768, filed Nov. 26, 2001. The disclosures of the above applications are incorporated herein by reference.

### BACKGROUND OF THE INVENTION

1. Field of the Invention

The present invention relates to a method of melting a specific portion of a material such as a plastic or metal by laser so as to weld a plurality of materials or to remove material from a specific portion of at least one material and to an apparatus for working that method.

2. Description of the Related Art

In the laser welding of plastic used in the past, a laser beam was focused by an ordinary optical lens to form a single point on part of the surface of the target worked material and thereby form a high temperature welding point at the focused point. That welding point was successively moved in a line over the surface of the worked material so form a bonded line. Alternatively, the single point of the laser beam focused on the surface of the worked material to form a high temperature welding point was maintained fixed at a certain point in space and the work table supporting the worked material was successively moved to draw a bonded line on the surface of the worked material.

With the method of successively moving a welding point in a line on a worked material, when for example bonding a plastic film to the surface of a plastic base, the film is heated by the focused point of the laser light along the bonded line and successively bonded in a heat expanded state, while there is no heat expansion at the not bonded portions, so tension occurs in the film. As a result, not only does the film as a whole warp, but also the surface of the base to which the film is to be bonded swells at the welding points, so clearance occurs and unbonded portions remain. Therefore, defects such as poor air-tightness, insufficient strength, defective shape, and other defects in the initial quality of the film are caused or concerns arise in durability such as later breakage of the film along the bonded line later due to residual stress.

To eliminate these problems, the method of scanning the surface of a worked material with a laser beam at a high speed using a so-called galvanoscanner to weld the entire worked material relatively quickly, though not to the extent of simultaneous block bonding, has been experimented with. With this method, however, it is necessary to move the lens at a high speed for scanning the surface by the laser beam. When the surface area of the worked material is large, however, the distance from the lens to the working point changes rapidly by a large extent along with the scanning. Due in part to this, forming a focused point of a constant size from a laser beam on the surface of the worked material is difficult. Further, the equipment is complicated and high in price, so there was the problem of a higher cost of the product when using this method.

### SUMMARY OF THE INVENTION

An object of the present invention is to solve these problems by a novel means and provide a method enabling simultaneous block welding or block removal of a material by laser which is not accompanied with deformation of the worked material or other problems, enables completion of the operation stably in a short time, streamlines the configuration of the system used, and is not liable to cause a rise in cost and an apparatus for working that method.

According to the present invention, there is provided a simultaneous block melting method using a laser comprising introducing a laser beam generated from a YAG laser source or the like into a diffraction type optical element like a diffraction lens and processing it into a beam of a predetermined shape by diffraction and transmission, then focusing the beam on a target area of a worked material. Due to this, all of the portion of the worked material focused on by the laser beam is heated and substantially simultaneously melts. Therefore, unlike with the successive melting method of scanning the surface of a material with a focused point of a laser beam, the entire worked portion simultaneously is heated and melts. Therefore, it is possible to perform the later welding or removal work all at once and the worked material is not liable to deform. Further, the work time can be remarkably shortened, so the productivity is improved and the cost reduced.

As a preferred mode of the simultaneous block melting method, it is possible to split a laser beam into a plurality of beams by diffraction and transmission in the diffraction type optical element, and then simultaneously focus the beams on target areas of the worked material to form a plurality of focused points on the surface of the worked material. Heat is generated at these focused points, so the material substantially simultaneously melts at the plurality of focused points. If increasing the number of focused points to make them approach to each other or enlarging the diameters of the focused points, the plurality of focused points become linked to form a continuous line. This enables any pattern to be drawn. Since a diffraction type optical element is used to split the laser beam, there is no liability of partial offset of the focused points.

Since it is possible to simultaneously form melted portions at any positions over a broad area of the worked material, by applying this method to a method of welding a material, it becomes possible to simultaneously heat and melt all of the portions to be bonded and thereby complete the welding with the opposing material all at once. Therefore, it becomes possible to avoid the various problems occurring due to deformation of the worked material such as with the conventional successive welding of scanning a surface with a single focused point of a laser beam.

This melting method can be used for welding a transparent material and an opaque material. That is, it is possible to use an opaque plastic or metal or other material absorbing the laser beams as a material to be heated and use a transparent plastic or glass or other material passing the laser beams as the other material to be bonded with. In this case, the laser beams pass through the transparent material and are focused on the opaque material. Due to this, the opaque material at the positions of the focused points is heated and melts. Part of that heat is also given to the parts of the transparent material contacting those focused points. Depending on the material, those parts also melt. Therefore, the two materials are easily bonded.

This melting method can be also used for simultaneous block removal of parts of a material by removing the melted parts of the worked material. As the means for removing the melted material, it is possible to utilize various means such as naturally occurring means like surface tension and blowing of a fluid etc. Further, in the removal of the material, it is possible to melt and remove parts of a plastic on a metal base, remove melted material for forming through holes in a material, etc.

Since the method of the present invention uses a diffraction type optical element, it is possible to split off part of the laser beam and measure the energy level of the split off laser beam by a power sensor or other means so as to estimate the amount of energy of the laser beam focused on the worked material. Due to this, it is possible to monitor and judge the quality of the work in real time during the actual work process.

The apparatus for simultaneous block melting of a material by laser of the present invention for working this method, more particularly a welding apparatus or removal apparatus of the same, is not limited to any particular diffraction type optical element for processing the laser beam before focusing, but preferably use is made of a block of zinc selenide formed with relief shapes or step differences by photolithography and etching.

### BRIEF DESCRIPTION OF THE DRAWINGS

These and other objects and features of the present invention will become clearer from the following description of the preferred embodiments given with reference to the attached drawings, in which:

FIG. 1 is a conceptual view of the system configuration of a simultaneous block welding apparatus according to a first embodiment of the present invention;

FIGS. 2A to 2D are plan views illustrating patterns of joints;

FIG. 3 is a conceptual view showing the concrete configuration of principal parts of a simultaneous block welding apparatus according to a second embodiment of the present invention;

FIG. 4 is a plan view concretely illustrating a pattern of joints; and

FIG. 5 is a conceptual view of the system configuration of a simultaneous block welding apparatus according to a third embodiment of the present invention.

### DESCRIPTION OF THE PREFERRED EMBODIMENTS

Preferred embodiments of the present invention will be described in detail below while referring to the attached figures.

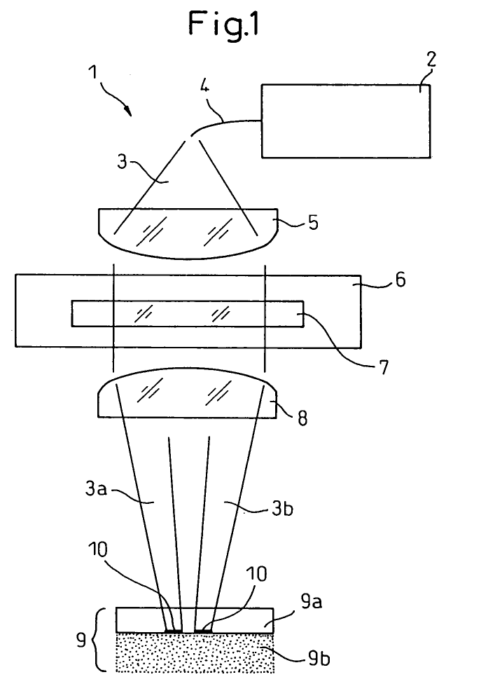

As a first embodiment of the present invention, FIG. 1 shows the basic configuration of a laser simultaneous block welding apparatus for plastic. Reference numeral 2 is a YAG laser source provided with a not shown excitation use light source, YAG rod, etc. As is well known, a YAG rod is a single crystal of yttrium aluminum garnet (complex oxide of yttrium oxide and aluminum oxide) including a trace amount of the rare earth element neodymium (Nd) which generates a YAG laser beam 3 of a wavelength of 1064 nm when excited by powerful light fired from the excitation light source.

Note that the laser beam able to be used in the simultaneous block welding apparatus is not limited to just a YAG laser beam, but a laser beam having a long wavelength in the infrared region has a strong heat action, so processing (cooling) the heat generated in the system becomes difficult. Therefore, use of a laser beam having too long a wavelength should be avoided.

The 1064 nm wavelength laser beam 3 generated in the YAG laser source 2 is guided by an optical fiber 4 to a lens 5 where it is adjusted to a predetermined diffusion angle, then strikes a beam-splitting diffraction lens 7 provided inside a cooling unit 6. The diffraction lens 7 is provided in the cooling unit 6 because the diffraction lens 7 generates some heat when splitting the laser beam 3. The cooling unit 6 is designed to be able to send cooling water or another cooling medium around the diffraction lens 7. Note that the optical fiber 4, lens 5, cooling unit 6, etc. shown in the first embodiment are not essential. It is also possible to configure the apparatus so that a laser beam output from the YAG laser source 2 directly strikes the diffraction lens 7 or to use something in place of the optical fiber 4.

The beam-splitting diffraction lens 7 referred to here is generally something that should be called a “diffraction type optical element”. It differs from a usual optical lens in that it splits a single laser beam 3 into a plurality of laser beams 3a, 3b . . . using the phenomena of diffraction and transmission of light. As is well known, the phenomenon of diffraction of light is the phenomenon where a beam of light such as a laser beam, which inherently should proceed straight, is partially bent at an edge part of an obstacle in its direction of advance and sneaks around to the part hidden behind the obstacle. The diffraction lens 7 used in the present invention is for example a material having a high transmittance of a laser beam such as a block of zinc selenide (ZnSe) formed on its surface with a specific pattern of relief shapes and step differences in accordance with the application. It is possible to use the diffraction phenomenon and transmission phenomenon of the laser beam at the edges formed by the relief shapes or step differences and combine a plurality of edges to split a single laser beam 3 into any number of laser beams 3a, 3b . . . oriented in any direction.

The simultaneous block welding apparatus 1 of the first embodiment is provided with a condensing lens 8 for independently focusing the plurality of laser beams split by the diffraction lens 7 and orienting them in desired directions. For the condensing lens 8, at least one ordinary optical lens is used.

In FIG. 1, reference numeral 9 shows generally a worked material (workpiece) for the welding of the present invention comprised of a plastic such as polypropylene (PP), polycarbonate (PC), polyamide (PA), and polybutylene terephthalate (PBT). Note that in this embodiment, all of the worked materials are made plastics, but for example it is also possible to melt iron plate of a thickness of 0.1 to 0.2 mm etc. by the same apparatus. Therefore, the worked material may be a metal, glass, etc. in addition to a plastic.

In this case, the surface layer workpiece 9a is either comprised of only a plastic material as explained above so as to pass YAG laser beams and not heat up much at all or is comprised of a plastic material with a high transmittance including transparent dyes or additives. The workpiece 9b to which the workpiece 9a of the transmitting plastic is to be bonded is comprised of a laser beam absorbing plastic consisting of a plastic such as explained above containing carbon particles or other pigments so as to absorb the YAG laser beams and heat up.

The diffraction lens 7 is given a specific pattern of relief shapes and step differences so as to form a desired pattern of joints 10 at the interface of the parts of the workpiece 9, that is, the transmitting workpiece 9a and the absorbing workpiece 9b to be welded with the same. The diffraction lens (diffraction type optical element) 7 utilizes the diffraction phenomenon of light etc. to split a single laser beam 3 into a plurality of beams 3a, 3b . . . and is used for orienting them to the target joints 10. The process for forming a specific pattern of relief shapes or step differences on the surface of the zinc selenide block of the material of the diffraction lens 7 uses photolithography and etching and resembles the process of forming an integrated circuit on a semiconductor.

That is, the zinc selenide block is covered on its surface with an etchant-resistant resist comprised of a photosensitive material, then the resist film is exposed through a photomask formed with holes corresponding to the recesses to be provided. The photosensitized parts of the resist are removed by development, then the surface is chemically etched to cut it to a predetermined depth at just the parts from which the resist film was removed by the previous development process and thereby form recesses. Finally, the resist film remaining at the non-etched parts is removed. By repeating this process the necessary number of times, a diffraction lens (diffraction type optical element) 7 formed with the desired pattern of relief shapes and step differences is obtained.

To produce the diffraction lens 7, in addition to the above photolithography and etching method, it is also possible to utilize etching by the recently developed grey scale mask and thereby produce a diffraction lens 7 having smooth relief shapes with no sharp step differences.

When the laser beam 3 striking the diffraction lens 7 passes through the diffraction lens 7, the laser beam 3 is transmitted and diffracted in the designed order and split into a plurality of beams 3a, 3b . . . oriented in predetermined directions. These strike the transmitting workpiece 9a, pass through it, then are focused at the interface with the absorbing workpiece 9b. At the focused points, the laser beams 3a, 3b . . . are absorbed by the absorbing workpiece 9b and changed to heat. That heat causes the surface of the absorbing workpiece 9b to melt and is also transmitted to the transmitting workpiece 9a in contact with the focused points to cause those surface portions to melt. The portions of the focused points become joints 10 between the transmitting workpiece 9a and the absorbing workpiece 9b. After cooling, these joints 10 firmly bond the workpieces.

Note that while it is not impossible to realize a splitting action similar to that of the diffraction lens 7 by combining a large number of prisms, slits, masks, ordinary optical lenses, etc., in that case the configuration of the optical system would become extremely complicated and therefore high in price. Further, the amount of waste heat produced in the system would increase and cooling would become difficult. If trying to realize a similar splitting action by a simply configured optical system, however, it would become difficult form focused points equally at all of the joints 10. As opposed to this, in the present invention, this is realized basically by a single diffraction lens 7. This is advantageous not only in terms of the price, but also the issue of heat generation. A diffraction lens itself is already known, but the present invention is characterized by the realization of a simultaneous block melting method and apparatus for a worked material using this as a means for splitting a laser beam.

If working the above method using the simultaneous block welding apparatus of the present invention, it is possible to form focused points distributed at desired positions simultaneously over a broad area of the workpiece 9 by the diffraction lens 7, so it is possible to form any pattern of joints 10 on the surface of the workpiece 9 all at once for simultaneous welding. Therefore, there is no problem of the workpiece being warped or otherwise deformed or poor air-tightness or insufficient strength of the joints arising as with the conventional method of successive welding drawing a bonded line by scanning a surface with a welding point of a single focused point.

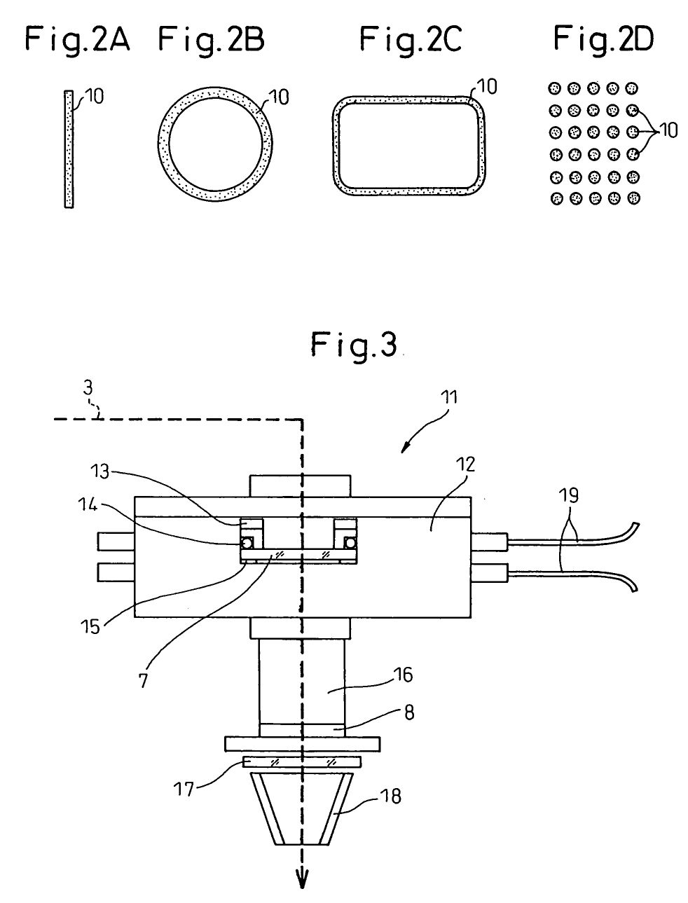

FIGS. 2A to 2D show several patterns of joints 10. FIG. 2A shows a line-shaped pattern, FIG. 2B a ring-shaped pattern, and FIG. 2C a rounded corner rectangularly shaped pattern. FIG. 2D shows a pattern of a large number of points equally distributed. Of course, it is also possible to arrange a large number of points zig-zagged or randomly instead of in a grid. It is possible to select from these patterns the one optimal for forming joints 10 on the facing surfaces of the two workpieces 9a and 9b. For example, the closed pattern of FIG. 2B or FIG. 2C is effective when forming a plastic package all at once. The multi-point pattern of FIG. 2D can also be utilized for a work process for partially removing plastic in a flexible board of an electronic circuit.

Among these patterns, as shown in FIG. 2A to FIG. 2C, the patterns having continuous line shapes or curved shapes can be formed with no joins by properly designing the diffraction lens 7, but it is possible to either form a large number of focused points by the diffraction lens 7 and thereby make the joints 10 approach the desired continuous shape or else reduce the focus of the focused points and thereby connect adjoining focused points so as to draw a substantially continuous pattern by a large number of points. Therefore, sometimes the design of the diffraction lens 7 becomes easier than when drawing a continuous pattern from the start.

FIG. 3 shows a second embodiment of the present invention. In the second embodiment, the configuration of the principal parts of the simultaneous block welding apparatus 11 for working the invention is shown more concretely and in more detail than the case of the simultaneous block welding apparatus 1 of the first embodiment. In FIG. 3, the illustration of the source of the laser beam is omitted, but in this case as well a laser source similar to that of the first embodiment is provided to generate the YAG laser beam 3 of a wavelength of 1064 nm. The principal parts, that is, the main body, of the simultaneous block welding apparatus 11 of the second embodiment is housed in a housing 12.

Inside the housing 12 are provided, in order in the direction of advance of the laser beam 3, a positioning use latch 13, an O-ring 14 for maintaining a hermetic state, a diffraction lens 7 as explained above, and lens protecting paper 15 for protecting the diffraction lens 7 and gripping it with the latch 13 to support it at a predetermined position. The laser beam 3 is subjected to the necessary splitting action using the transmission and diffraction phenomena of light so as to form the joints 10 drawing the desired pattern when passing through the diffraction lens 7. The split laser beams 3 pass through an extension tube 16 connected to the housing 12 for adjusting the working points and pass through the condensing lens 8 for focusing. Further, they pass through protective glass 17 provided to prevent the intrusion of a gas etc. and pass through an assist gas ejecting nozzle 18 (optional) to strike the not illustrated workpiece 9 and form the predetermined pattern of joints 10 at the focused points.

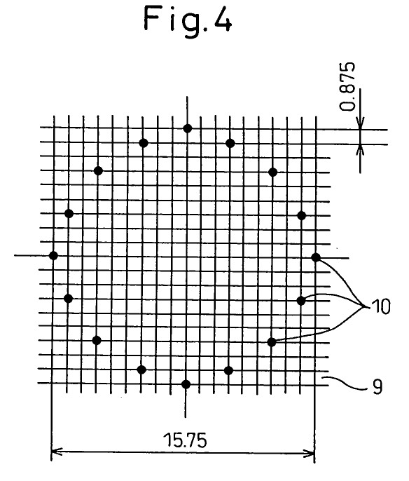

The pattern of the joints 10 in this case, as explained above, may be made any of the shapes shown in FIG. 2A to FIG. 2D. Illustrating a more concrete shape, for example, it is possible to form a ring-shaped pattern comprised of 16 points arranged on a circle as shown in FIG. 4. In this case, the laser beam striking the diffraction lens 7 is split into 16 fine laser beams 3 by the transmission and diffraction action. These beams form the same number of focused points on the workpiece by the condensing lens 8 so as to enable the formation of the 16 joints 10 shown in FIG. 4. That is, the 16 beams are focused to points, heat the workpiece 9 at those points, and thereby melt the plastic and cause welding with the opposing object. In some cases, it is also possible to remove the plastic melted at the focused point positions. In this case, the plastic at the melted parts is removed naturally by the surface tension, but it is also possible to blow air or another fluid to forcibly remove it. Note that the units of the dimensions illustrated in FIG. 4 are “mm”.

In this case, if defocusing the focused points to increasing their diameter, the individual focused points can become linked with the adjoining points to form close to a continuous ring-shaped joint (or removed part) such as shown in FIG. 2B. Note that in the simultaneous block welding apparatus 11 of the second embodiment shown in FIG. 3, cooling water is circulated in the housing to cool the diffraction lens 7 etc. The cooling water piping for this is shown by reference numeral 19 in FIG. 3.

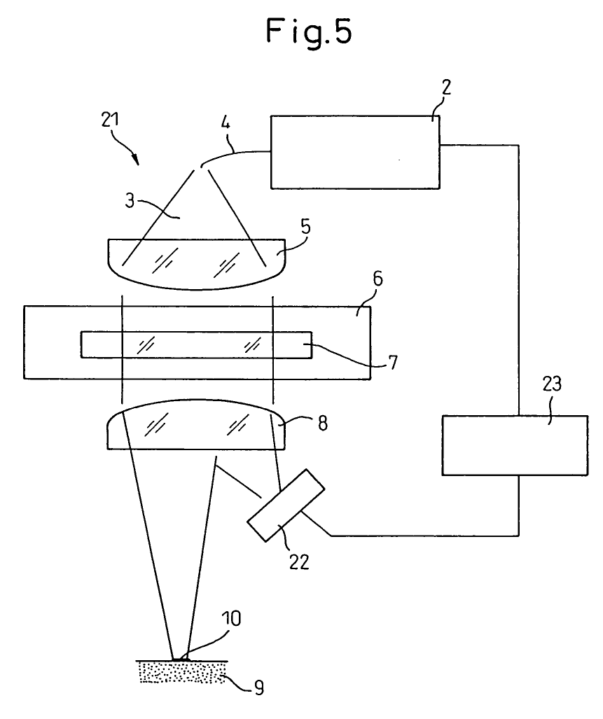

When using a diffraction lens 7 (generally a diffraction type optical element) to weld, remove parts of, or otherwise process a plastic workpiece 9 by laser as explained above, sometimes it is desirable to detect or monitor the energy level of the laser beams actually acting on the joints 10 (generally the working points). In the simultaneous block melting apparatus of the present invention, it is possible to easily detect the energy level (amount of energy) of the laser beams actually acting on working point in accordance with such a need by adding to part of the apparatus a detecting means and a signal processor. An example of this is given as a third embodiment. FIG. 5 shows the system configuration. Note that parts similar to those of the first embodiment (FIG. 1) explained above are assigned the same reference numerals and overlapping explanations are omitted.

The point of difference of the simultaneous block welding apparatus 21 of the third embodiment from the simultaneous block welding apparatus 1 of the first embodiment is that a power sensor 22 is provided inside the system so as to receive part of the laser beam 3 split off by the diffraction lens 7 and the output signal of the sensor 22 is supplied to a processing circuit 23. The processing circuit 23 can estimate the overall energy level from the energy level of the part detected based on a premeasured ratio and thereby detect and display the amount of energy acting on working points such as joints 10 in real time with sufficient accuracy.

In a conventional laser plastic welding apparatus, an energy monitor provided inside the laser source was generally used to monitor the energy level of the laser beam generated, but with this system, it is not possible to detect the amount of energy actually acting on the working point. Detecting the amount of energy of a working point required that the work be suspended and measurement be performed by a power meter. As opposed to this, in the simultaneous block welding apparatus 21 of the third embodiment, it becomes possible to accurately monitor the changes in the amount of energy during work at a location nearer to the workpiece 9 than the laser source 2.

While the invention has been described with reference to specific embodiments chosen for purpose of illustration, it should be apparent that numerous modifications could be made thereto by those skilled in the art without departing from the basic concept and scope of the invention.

What is claimed is:

1. A laser-melting apparatus focusing a laser beam on an object to be melted, comprising:
a laser source generating a laser beam having a predetermined beam shape;
a diffraction type optical element outputting the laser beam having a predetermined beam shape by diffraction and transmission of the laser beam input from said laser source; and
a condensing lens condensing the laser beam output from said diffraction type optical element and orienting to said object to be melted; wherein
said diffraction type optical element splits an input single laser beam into a plurality of output beams and then outputs them.

2. A laser-melting apparatus as set forth in claim 1, further comprising a power sensor receiving either of the plurality of output beams and detecting the energy level thereof, and a processing circuit processing the output of said power sensor and estimating the overall energy level focused on said object.

3. A laser-melting apparatus as set forth in claim 2, wherein said condensing lens is single and whereby the plurality of output beams are focused simultaneously and respectively.

4. A laser-melting apparatus as set forth in claim 3, further comprising a lens disposed between said laser source and said diffraction type optical element, adjusting the laser beam output from said laser source to a predetermined diffusion angle, then inputting the same into said diffraction type optical element.

5. A laser-melting apparatus as set forth in claim 1, further comprising a cooling unit cooling said diffraction type optical element.

6. A laser-melting apparatus as set forth in claim 1, wherein at least one of the plurality of output beams has a beam shape different from the shape of the input single laser beam.

7. A laser-melting apparatus as set forth in claim 1, wherein a joint portion is formed at a plurality of positions away from each other on said object.

8. A laser-melting apparatus as set forth in claim 7, wherein said condensing lens is single and whereby the plurality of output beams are focused simultaneously and respectively.

9. A laser-melting apparatus as set forth in claim 8, further comprising a lens disposed between said laser source and said diffraction type optical element, adjusting the laser beam output from said laser source to a predetermined diffusion angle, then inputting the same into said diffraction type optical element.

10. A laser-melting apparatus as set forth in claim 9, further comprising a cooling unit cooling said diffraction type optical element.
